(19) United States
(12) Patent Application Publication
(10) Pub. No.: US 2024/0127214 A1
(43) Pub. Date: Apr. 18, 2024

(54) SYSTEMS AND METHODS FOR IMPROVING MACHINE LEARNING MODELS

(71) Applicant: THE TORONTO-DOMINION BANK, TORONTO (CA)

(72) Inventors: MATTHEW CARLTON FREDERICK WANDER, BLUE BELL, PA (US); HOLLY HEGLIN, TORONTO (CA); MING JIAN PAN, SCARBOROUGH (CA)

(21) Appl. No.: 17/956,531

(22) Filed: Sep. 29, 2022

(51) Int. Cl. G06Q 20/20

(52) U.S. Cl. CPC G06Q 20/20

(57) ABSTRACT

Computational systems and methods are provided to automatically assess residual characteristics of an existing machine learning model to identify and determine suboptimal pockets and augmentation strategies. A computing system, device and method for optimizing a machine learning model for performing predictions is provided. The computing device performs sub-optimal pocket identification on an existing machine learning algorithm by residual analysis to calculate an error. The computing device utilizes the residual as a target for an ensemble tree model and automatically generates a set of interpretable rules from the tree based ensemble model that contribute to the suboptimal pockets. The rules indicating relationships between features and interactions as well as values for the sub-optimal pockets. The computing device determines optimizations for improving the machine learning model based on the interpretable computer-implemented rules.

### FIELD

The present disclosure relates generally to systems and methods for machine learning model generation and more particularly, to systems and methods for augmenting existing machine learning models by applying additional machine learning techniques including ensemble trees.

### BACKGROUND

There are conventionally, many different machine learning techniques and models for generating predictions of future outcomes or events by analyzing patterns in a given data set of input. However, machine learning models may grow old and they may become inaccurate over time and show signs of decay. They may for example experience data drift, concept drift or other challenges that the model is simply not performing as well as it is expected. That is, even if there aren't drastic changes, small changes may accumulate that result in degraded performance and inaccurate predictions. In some cases which prediction is being performed, the input data is constantly changing and the models are unable to adapt accordingly become invalid.

Also, once these machine learning models are built, if their performance is sub-optimal or otherwise inaccurate in performing predictions, there is typically little interest in replacing existing models as such replacement would be risky, costly, difficult to implement within existing systems and may cause disruptions to the computing systems involved that increases the computational resources required for corrections to the systems. Additionally, there may be risks involved with replacing or rebuilding models altogether and additionally computational resources to determine such risks and recalibrate existing systems.

Some of the technical challenges in updating existing prediction models for improvement in loss or performance is that replacing the existing strategy and models with a new prediction model built from scratch may be resource intensive, risky, cause other implications and difficult to implement. Additionally, in a black box environment of machine learning, even if the model is re-built it will be difficult to understand and trust its implementation.

### SUMMARY

Thus, there is a need in the art for a method and system to automatically improve existing machine learning models and address issues of model performance decay.

It is an object of the present disclosure to identify segments within data for better predictions using data driven techniques leading to improved model performance.

An example implementation is an adjudication strategy and underlying prediction models which are sub-optimal in assigning risk based assessments to particular input data, e.g. groups of customer applications (e.g. loans) in determining the adjudication strategy. As the model performance decays, there may be a need for better adjudication and improved model performance for reducing computing resources spent on determining errors of the model.

Some of the example technical computational challenges in updating low performing or model decay in machine learning models (e.g. caused by data drift, concept drift or poor performance in general) may include: replacing the existing strategy and models with a new prediction model built from scratch would be computationally resource intensive, and difficult to implement as removing the model or updating it may affect a number of connected computing devices and systems that will also need to be updated to work with the newly built model. In at least one implementation, another technical challenge is that any changes to the model or to additional computing systems correcting the prediction model(s) experiencing decay or needing updating need to be highly transparent and interpretable for ease of implementation. Additionally, in at least one aspect, any proposed changes to the prediction models should apply to a sizable portion of the population for there to be significant impact (and therefore an improvement).

In one aspect, there is provided a computer implemented method for optimizing a machine learning model for performing predictions, the method comprising: invoking a machine learning algorithm to perform a first prediction of a likelihood of occurrence of an event based on a set of input features and trained on historical data; performing sub-optimal pocket identification by analyzing the first prediction of the machine algorithm over a historical time period as compared to actual performance, as retrieved from a database, to calculate an error difference between the actual performance and predicted performance over the historical time period, when the error difference exceeding a defined threshold indicative of a particular sub-optimal pocket; applying the error difference indicating a residual as a target variable to an ensemble decision tree model used for prediction along with the set of input features to output a set of decision trees, each of the decision trees being trained on errors of a prior tree and each leaf node in a tree identified as a rule for the prediction of the target, the rule indicating a combination of the input features and boundary value ranges for the input features based on traversing each of the decision trees to the leaf node; and, determining one or more optimizations for the sub-optimal pocket of the machine learning algorithm based on corresponding rule sets derived from the output of the decision trees and triggering an action to invoke adjusting the machine learning model based on the optimizations.

In one aspect, the prediction performed by the decision tree model is a sum of respective predictions performed by each one of the set of decision trees generated and combined to form the prediction.

In one aspect, the method further comprises: for each leaf node of each decision tree in the set of decision trees having a corresponding rule, generating a linear model representing an interpretable decision tree for predicting the target variable based on a sum of a product of weighted values of features and the corresponding rule, each weighting automatically generated and associated with probabilities for the features in a given node.

In one aspect, the method further comprises: ranking each rule generated from each leaf node of each decision tree in the set of decision trees to generate a ranked list by calculating an effect of each rule, the effect calculated as a product of a leaf count indicating a frequency of occurrence of nodes satisfying a particular rule within the decision tree and a coefficient for the particular rule indicating the weighting for features in the particular rule based on a summation of all of the decision trees in the set of decision trees.

In one aspect, determining the optimizations further comprises: selecting a predefined number of rules in the ranked list having a highest value of the calculated effect as compared to remaining other rules; automatically inputting the selected rules to a feature analysis engine for simulating modifying the first prediction for each of the selected rules and simulating whether the machine learning algorithm improves in performance based on the modification; and in response to an improvement detected based on the modification, defining the modification as one of the optimizations for automatically adjusting the machine learning algorithm.

In one aspect, the method further comprises: selecting a second set of rules in the ranked list having the calculated effected below a defined threshold as compared to the remaining other rules; determining one or more corresponding features and associated values in the second set of rules; invoking the machine learning algorithm to remove the one or more corresponding features in the second set of rules having the associated values from the input features thereby removing irrelevant features from consideration in the first prediction.

In one aspect, the ensemble decision tree model is selected from one of: gradient boosted machine, light gradient boosted machine, extreme gradient boosted, random forest, and bagging algorithms.

In one aspect, the prediction for the ensemble decision tree model is computed as a sum of predictions for all of the set of decision trees and computed as:
ŷᵢ=Σᵢ₌₁^{N}Tᵢ, with ŷt indicating the total prediction and Tᵢ referring to each tree in the set of decision tree.

In one aspect, the prediction for the ensemble decision tree model is converted to a sum of a product of probability of occurrence for each leaf node and a corresponding rule set for said each leaf node in traversing a path throughout each decision tree and computed as:
Tᵢ=Σ_{L}_{ⱼ}_{∈T}_{ᵢ}wⱼ [symbol] (Lⱼ); with w representing the weighting; and L representing a particular rule in terms of original input features as a linear model; and the prediction represented as:

$${\hat{y}}_{i} = {\sum }_{i = 1}^{N} {T}_{i} = {\sum }_{i = 1}^{N} {\sum }_{{L}_{j} ∈ {T}_{i}} {w}_{j} ( {L}_{j} ) = {\sum }_{{L}_{k} ∈ \{ {T}_{1} , ... , {T}_{n} \}} {w}_{k} ( {L}_{k} ) ; \\ such that :$$

$$( x ) = \{ \begin{matrix}1 & if x is true \\ 0 & otherwise\end{matrix}$$

In one aspect, the method further comprises: rendering the ranked list of rules in the set of decision trees with the effect of each rule as an interactive interface element on a graphical user interface for confirming one of the optimizations generated for adjusting the machine learning algorithm.

In one aspect, there is provided a computing system for optimizing a machine learning model for performing predictions, the computer system comprising a processor, a storage device and a communication device where each of the storage device and the communication device is coupled to the processor, the storage device storing instructions, which when executed by the processor configured the computing system to: invoke a machine learning algorithm to perform a first prediction of a likelihood of occurrence of an event based on a set of input features and trained on historical data; perform sub-optimal pocket identification by analyzing the first prediction of the machine algorithm over a historical time period as compared to actual performance, as retrieved from a database, to calculate an error difference between the actual performance and predicted performance over the historical time period, when the error difference exceeding a defined threshold indicative of a particular sub-optimal pocket; apply the error difference indicating a residual as a target variable to an ensemble decision tree model used for prediction along with the set of input features to output a set of decision trees, each of the decision trees being trained on errors of a prior tree and each leaf node in a tree identified as a rule for the prediction of the target, the rule indicating a combination of the input features and boundary value ranges for the input features based on traversing each of the decision trees to the leaf node; and, determine one or more optimizations for the sub-optimal pocket of the machine learning algorithm based on corresponding rule sets derived from the output of the decision trees and triggering an action to invoke adjusting the machine learning model based on the optimizations.

In one aspect, there is provided a computer program product comprising a non-transient storage device storing instructions that when executed by at least one processor of a computing device, configure the computing device for optimizing a machine learning model for performing predictions, the instructions once executed configured the computing device to: invoke a machine learning algorithm to perform a first prediction of a likelihood of occurrence of an event based on a set of input features and trained on historical data; perform sub-optimal pocket identification by analyzing the first prediction of the machine algorithm over a historical time period as compared to actual performance, as retrieved from a database, to calculate an error difference between the actual performance and predicted performance over the historical time period, when the error difference exceeding a defined threshold indicative of a particular sub-optimal pocket; apply the error difference indicating a residual as a target variable to an ensemble decision tree model used for prediction along with the set of input features to output a set of decision trees, each of the decision trees being trained on errors of a prior tree and each leaf node in a tree identified as a rule for the prediction of the target, the rule indicating a combination of the input features and boundary value ranges for the input features based on traversing each of the decision trees to the leaf node; and, determine one or more optimizations for the sub-optimal pocket of the machine learning algorithm based on corresponding rule sets derived from the output of the decision trees and triggering an action to invoke adjusting the machine learning model based on the optimizations.

### BRIEF DESCRIPTION OF THE DRAWINGS

These and other features will become more apparent from the following description in which reference is made to the appended drawings wherein:

FIG. 1 is a diagram illustrating an example computing environment and system including a model enhancement engine in communication with an existing machine learning model, in accordance with one embodiment;

FIG. 2 is a diagram illustrating a block schematic of an example computing device including the model enhancement engine, in accordance with one embodiment;

FIG. 3 is a diagram illustrating an example ensemble tree set generated by the model enhancement engine of FIGS. 1 and 2, in accordance with one embodiment;

FIGS. 4 and 5 are diagrams illustrating example tree sets generated by the model enhancement engine of FIGS. 1 and 2 and process for interpreting the decision trees, in accordance with an embodiment;

FIG. 6 is a diagram illustrating an example process for generating a rule set from an example ensemble tree having a plurality of decision trees, in accordance with one embodiment;

FIG. 7 is a diagram illustrating an example flow diagram of a process implemented by the example machine learning model and algorithm in FIG. 1, in accordance with one embodiment;

FIG. 8A is a schematic diagram of the process for an example of a decision tree set to perform a given prediction and FIG. 8B is a comparison plot for feature(s) of the machine learning model and potential simulated predictions, e.g. key score with a population, in accordance with one embodiment;

FIG. 9 is a graph showing an example correlation matrix between various features, in accordance with one embodiment;

FIG. 10 is a flowchart illustrating example operation of a computing device (e.g. the computing device of FIG. 2), in accordance with one embodiment; and,

FIG. 11 is a table illustrating example rule set generated by the engine of FIGS. 1 and 2.

### DETAILED DESCRIPTION

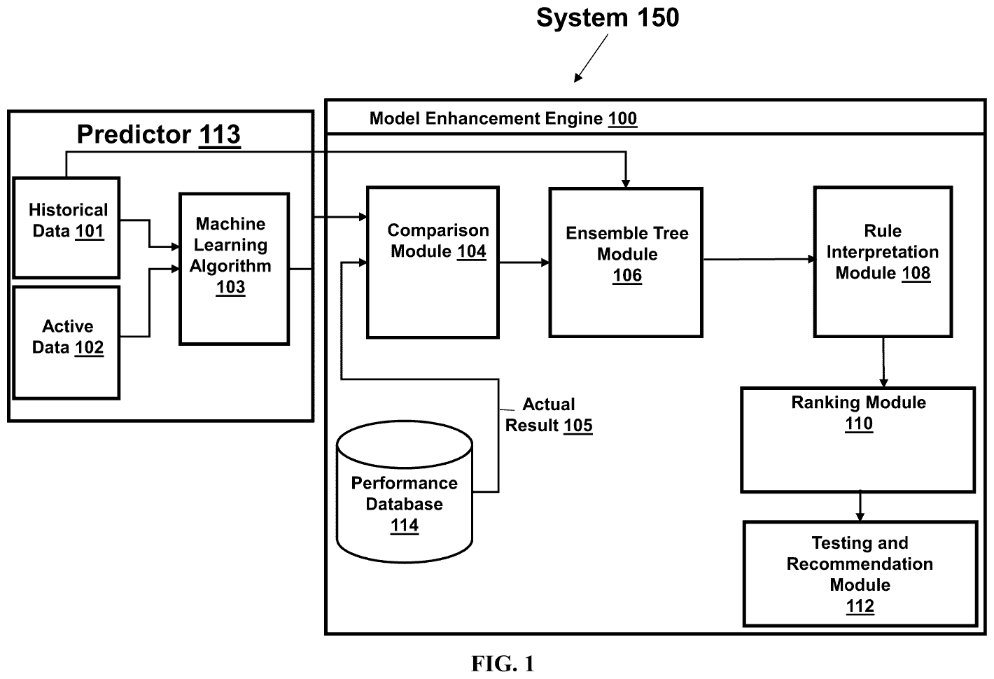

In at least some aspects and referring to FIG. 1, there is disclosed a machine learning pipeline and system 150 to automatically receive and identify sub-optimal predictions (e.g. sub-optimal adjudicated populations of applications in a current risk assignment based on prediction of delinquency strategy) obtained from a prior machine learning algorithm (e.g. predictor 113). Conveniently, in at least some aspects, the proposed systems and methods provided by the system 150 and particularly a model enhancement engine 100 lead to improved predictions and improved accuracy of such predictions, e.g. risk ranking with reduced interventions to correct errors (e.g. lower manual key decision overrides due to improved performance).

Generally, in one aspect, the system 150 comprises a model enhancement engine 100 utilizing ensemble trees, such as trained gradient boosted decision trees (GBDTs) having been trained on a performance error of the machine learning algorithm 103 to determine and model the performance errors (e.g. via a comparison module 104) of an existing prediction model's strategy (e.g. the machine learning algorithm 103) strategy and to utilize same for automated determinations of enhancements. As will be described, in at least some aspects, the comparison module 104 may be configured to calculate a difference between the expected predictions of one or more occurrences as forecasted by the machine learning algorithm 103 (e.g. having been trained on historical data 101 and utilizing features in active data 102 to predict a target occurrence, e.g. an occurrence of likelihood of delinquency based on historical data) and the actual occurrences of events based on historical data. That is, in some aspects, the comparison module 104 may determine which segments of time or based on features having been processed by the machine learning algorithm 103, the machine learning algorithm 103 perform predictions correctly or incorrectly and thereby flag incorrect prediction segments (e.g. performance of the machine learning algorithm 103 in a segment of time or for a certain population of input being below expected values) and provide such sub-optimal pockets to the ensemble tree module 106 for analysis along with features used to generate the machine learning algorithm 103, e.g. historical data 101 and/or active data 102 and other hyper parameters including time information and information relating to known data of occurrences of events.

In one aspect, the system 150 comprises an ensemble tree module 106 within the model enhancement engine 100 providing a plurality of gradient boosted decision trees which would model the residual, or errors of performance of a prior generated prediction model (e.g. machine learning algorithm 103) via detecting population or data segments from the input data (e.g. active data 102) where the prior model is performing sub-optimally via a comparison module 104 and determining potential enhancements to the algorithm 103 in cooperation with a rule interpretation module 108, a ranking module 110 and a testing and recommendations module 112.

Conveniently, in at least some aspects, the model enhancement engine 100 overcomes the computational complexity of the modelling challenge; instead of replacing the existing modelling strategy (e.g. replacing an existing machine learning algorithm 103 with a new model altogether) which may be error prone, complex, require additional computational resources, the proposed technique and system 150 adds enhancements on top of the existing prediction model (e.g. machine learning algorithm 103) that addresses the areas or segments in the prediction output provided from the machine learning algorithm 103 where the performance was sub-optimal (as calculated by the comparison module 104) in performing predictions such as to generate interpretable insights for improving the machine learning algorithm 103 (e.g. rule sets generated by the rule interpretation module 108 and the ranking module 110 containing associated input features and associated values having a significant effect on the computational performance of the machine learning algorithm 103) such as to invoke operations for optimization of the algorithm 103 (via testing and recommendation module 112) to provide an improved machine learning model (e.g. machine learning algorithm 103) and system as provided by the system 150.

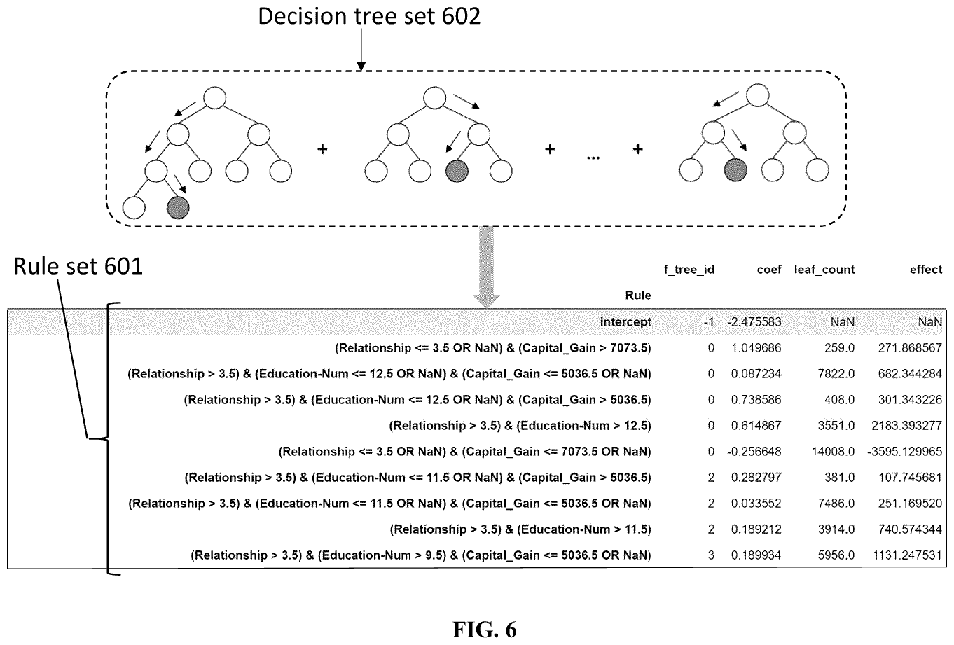

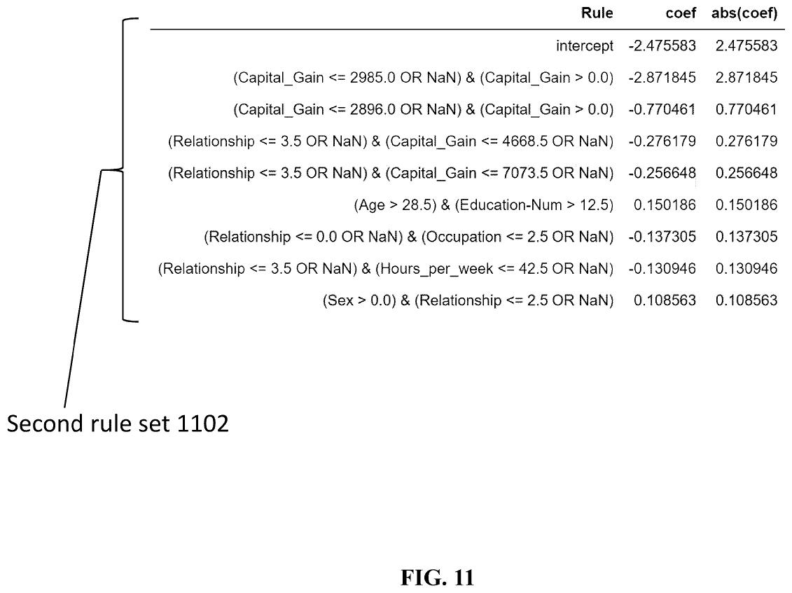

Additionally, in one aspect, there is disclosed an improved method and system 150 to provide decision tree ensembles (e.g. gradient boosted decision trees GBDTs) as may be provided by the ensemble tree module 106 that are configured to generate interpretable rules (e.g. used to correct the training of previously generated machine learning models) that are fully transparent. Such interpretable rules as shown by example in FIGS. 6 and 11 may include a set of input feature relationships and values that are attributing with various effects on the performance errors detected in the machine learning algorithm 103.

Tree ensembles may be black boxes providing high performance but low interpretability, but the disclosed systems and methods automatically derive information from the tree ensemble models and represent as a linear model on top of rule sets to provide high performance and interpretability, in at least some embodiments.

In at least some aspects, computer implemented data extraction tools and computing modules are used to extract the rules and linear representation, and to recommend (e.g. to one or more associated computing devices for the existing prediction module or user interfaces associated with the existing prediction module) a pre-defined number of highest performing rules determined from the tree ensemble which cover a defined percentage of the population of data transactions or customer data examined.

The ensemble decision tree models may include but not limited to: gradient boosted machine, light gradient boosted machine, extreme gradient boosted, random forest, and bagging algorithms.

As a result, in at least some implementations, the proposed computational enhancements as may be generated by the testing and recommendation module 112 consist of rules extracted from ensemble decision trees provided by the ensemble tree module 106 (that were implemented using the residual error of the machine learning algorithm 103 as the target variable) that carry the high performance of accuracy given by tree ensembles, and were interpretable enough (e.g. as provided by a set of rules by the rule interpretation module 108) to be useful for implementation and providing further understandability of the operations for improvement. Put another way, the residual defines a difference between an actual target value for a model and the fitted value.

Thus, there is proposed a machine learning system 150 and framework that is configured to capture data attributes (e.g. loan attributes within an input data set) more effectively than prior valuation methods to better determine a corresponding prediction, e.g. risk assessment based on predicted likelihood of delinquency from the data attributes.

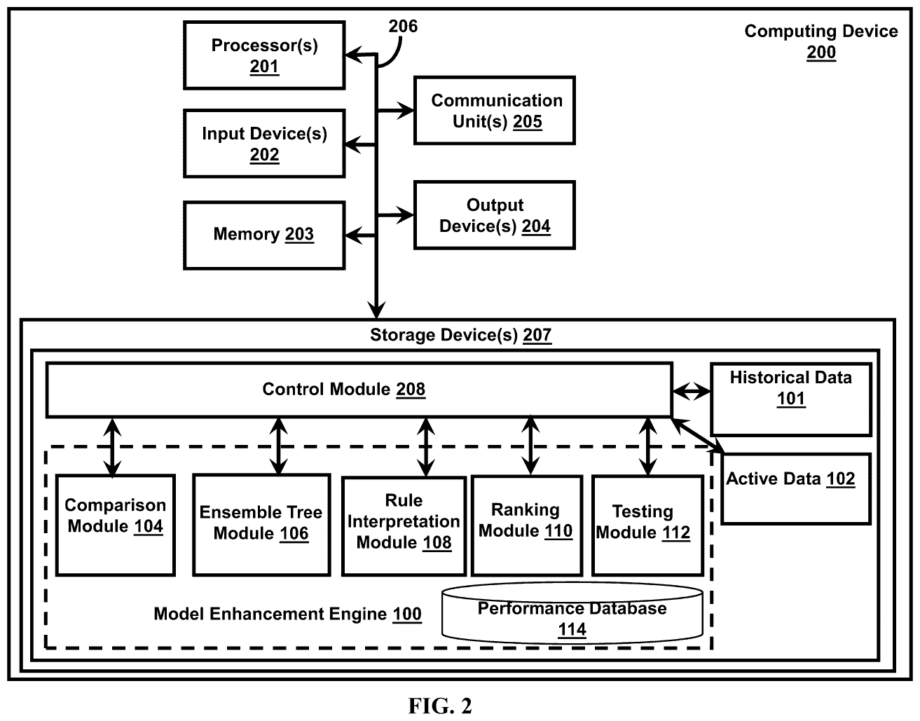

Referring in more detail to FIG. 1, shown is an example of a machine learning pipeline and system 150, according to one embodiment. The system 150 is configured to automatically identify sub-optimally determined populations or segments of predictions provided from a currently existing machine learning algorithm 103 (e.g. trained on historical for modelling the errors of the existing machine learning model and strategy and determining optimizations or enhancement for the machine learning algorithm 103 such as to address areas where it was sub-optimal. Additionally, as noted above, the tree ensembles provided by the ensemble tree module 106 are used to translate and generate fully interpretable rules by the rule interpretation module 108 such as linear models on top of the rule sets which may be better visualized by a computing system, device or server associated with the model enhancement engine 100 (e.g. computing device 200 of FIG. 2).

Referring to FIG. 1, the machine learning system 150 includes various modules and data stores for performing the operations described herein. These include a machine learning algorithm 103, a comparison module 104, an ensemble tree module 106, a performance database 114, an ensemble tree module 106, a rule interpretation module 108, a ranking module 110, and a testing and recommendation module 112. The machine learning algorithm being trained on historical data 101 and tested on active data 102 (e.g. during deployment). The machine learning algorithm 103 configured for predicting an occurrence or an event in a future time period based on input features extracted from active data 102 and prediction based learning from the historical data 101.

The prediction(s) from the machine learning algorithm 103 may be provided to the comparison module 104 as they are generated or periodically or stored in an intermediary storage device (not shown) for subsequent retrieval by the comparison module 104. Additionally, the comparison module 104 may retrieve actual results 105 relating to what the algorithm 103 was predicting from a performance database 114 and collected over a define time period relating to the future time which the machine learning algorithm was forecasting. In this way, the comparison module 104, receiving both the predicted values of the machine learning algorithm 103 and the actual result 105 indicating the real world occurrence or event over a given time period or for a given population or for other subsets of data in the active data 102, is configured to perform residual analysis and calculate the residual error for sub-optimal pocket identification in the input data. For example, the residual or error may be defined as the difference between actual and predicted performance of the model.

In one example implementation of the machine learning algorithm 103, the machine learning algorithm 103 may follow a series of processes 700 to adjudicate applicants based on input data for the applicants. In this example, the algorithm 103 may, given a customer base and associated data for a particular segment of time, assign a risk key 702 or a risk score tied to a prediction of a desired target, e.g. how likely a particular customer is to go delinquent.

The model enhancement engine 100 may be performed using a machine learning system which may include or be included in a computing device, a server, a cloud computing environment, or the like, such as the computing device 200 shown in FIG. 2. Similarly, the machine learning algorithm 103 and associated data stores, historical data 101 and active data 102, may include or be included in a computing device, a server, a cloud computing environment or the like, as described herein, shown as predictor 113 module.

As described earlier, the model enhancement engine 100 is generally configured to provide a machine learning pipeline to augment an existing machine learning system, such that provided by the predictor 113 including the machine learning algorithm 103. The model enhancement engine 100 is generally configured to take in prediction outputs, target variables, or feature data set derived from observations etc. and determine fixes or improvements to those areas or segments of the data determined to be sub-optimal (e.g. via the comparison module 104) such as to update the output prediction and in some implementations, provide optimizations for the suboptimal segments and feedback recommendations for updating the model in the predictor 113 for obtaining better performance.

In at least some aspects, the model enhancement engine 100 may be configured to determine a set of rules including input features and feature values or ranges, such as via the rule interpretation module 108 corresponding to the suboptimal regions of prediction identified by the comparison module 104 and then provide improved rules (e.g. to swap out values in the rules to yield improved rules) to integrate the improved rules into generating improved predictions (e.g. risk score ratings) by the machine learning algorithm 103.

Referring again to FIG. 1, once the comparison module 104 compares the actual performance of the machine learning algorithm 103 to the expected performance, this may be used by the comparison module to automatically detect sub optimal pocket identification providing a characterization of segment(s) of the input data or populations of the input data whereby the residual error exceeds a defined threshold and thereby indicates suboptimal performance. For example, the residual may indicate that certain populations of the input data, or data with certain attributes or portions of the input data segments (e.g. active data 102 used for prediction during deployment of the model) were not accurately predicted along with associated metadata characterizing the input data or segments of the data. In one example, the error may be calculated as:

Performance/Scorecard error=Actual Performance−Predicted Performance a.

In an example of predicting delinquency by the predictor 113, the actual performance may indicate whether a specific population and associated records actually went delinquent or not and this may be compared to predicted performance such as based on a risk key assigned as well as the score generated from the machine learning algorithm 103.

The engine 100 is configured to provide such indication of the residual error exceeding a desired amount along with any identification of the sub-optimal pocket(s) of the input data to the ensemble tree module 106 which receives the performance or prediction error (e.g. difference between the actual and predicted performance of the machine learning algorithm 103) as a target variable. Generally, the target variable may represent a value that a machine learning model, in this case, the ensemble tree module 106 consisting of a plurality of decision tree models, is being trained to predict and the feature set provided to the ensemble tree module 106 may represent all or portions of the feature set and/or observations from the machine learning algorithm 103 (e.g. the historical data 101 or the active data 102). Put another way, the target variable, in this case the performance error in the machine learning algorithm 103 is the feature of a data set to be understood more clearly and the variable that is to be predicted using the rest of the dataset (e.g. remaining features). The feature set may represent the variables input to a trained ensemble tree module 106 which are used to predict a value for the target variable, e.g. the prediction error. Thus, the target variable, e.g. the prediction or performance error calculated by the comparison module 104 is the variable whose values are modeled by the ensemble tree module 106 and predicted by other variables (e.g. features retrieved from the historical data 101 and/or active data 102). The ensemble tree module 106 may be trained on prior prediction/performance errors to predict a target variable and may be a supervised model or a predictive model.

Thus, in at least one embodiment, in the machine learning pipeline and framework of FIG. 1, the ensemble tree module 106 utilizes a target variable based on residual analysis on the predictor 113, e.g. a scorecard error and conveniently provides an output of a set of rules via the ranking module 110 associated with sub-optimal segments or pockets poorly predicted to use to optimize the prediction automatically as performed by the predictor 113 rather than simply producing a likelihood score or number that is in a black box format and cannot be easily confirmed or validated.

Thus, the target variable is used to measure how the model is performing based on the prediction error, e.g. score card error.

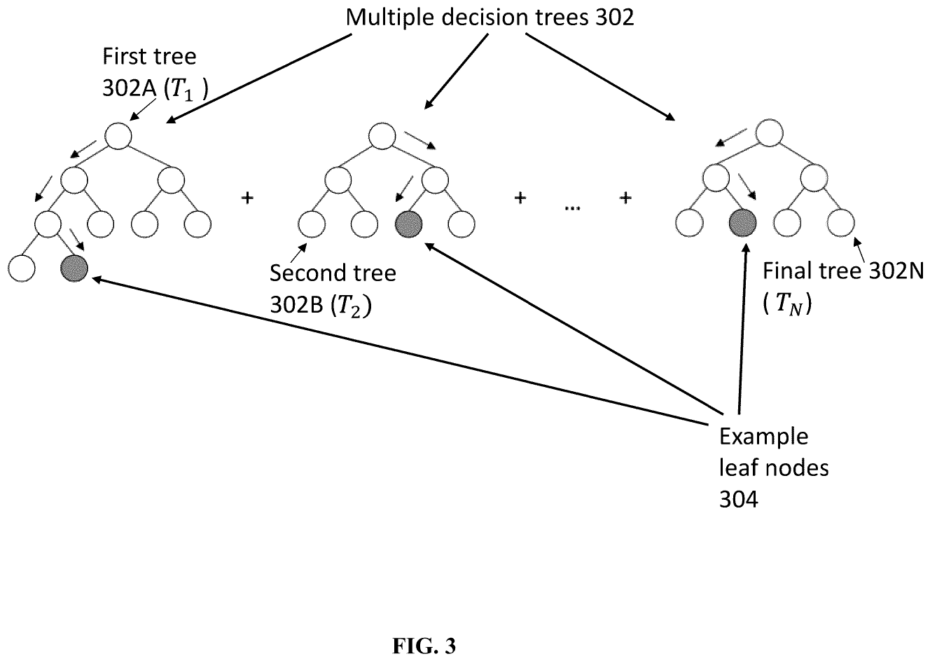

In at least some embodiments, the ensemble tree module 106 is able to provide a solution to predicting an outcome of interest, in this case the residual or performance error by simultaneously utilizing a number of models (e.g. see FIG. 3). This approach is able to outperform single models as the models as a whole work together to provide improvements. However, as noted earlier, tree ensembles while having a high performance and accuracy are difficult to understand and in the present embodiment, the rule interpretation module 108 is configured to generate interpretable trees system that extracts and selects rules from a tree ensemble via their calculated effect (e.g. via the ranking module 110) such that such simplified rule sets may be utilized for future predictions and to improve the machine learning algorithm 103.

An example of the multiple decision trees 302 are shown at FIG. 2 whereby multiple trees are trained using gradient boosting and each tree is trained on the errors of the previous tree. Additionally, each leaf node (or end node) in a tree may be represented as a rule, such as via rule interpretation module 108 configured to convert trees into rules. As will be described, the rule interpretation module 108 is configured to convert multiple decision trees 302 into rule sets. Put another way, the rule interpretation module 108 may be configured to capture the path through each decision tree 302 (or decision tree set 602 in the example of FIG. 6) to a leaf node into a decision rule such as that shown at rule set 601 in FIG. 6 converting and decomposing each tree of the ensemble tree set into decision rules which include features, values or range of values for the features and relationships between two or more features as shown in the rule set 601. For example, the rule set 601 may capture the interactions between a set of original features as having traversed a particular tree to reach a leaf node. Additionally, the rule set 601 may identify the corresponding tree identification, the coefficient or weighting associated with each rule and a leaf count for the rule. Additionally, the rule set 601 generated by the rule interpretation module 108 may determine the effect or importance of each rule within the rule set. Thus, each node in every tree is associated with a rule and the rule interpretation module 108 is configured to extract all the rules (e.g. corresponding to leaf nodes within each tree) and determine the weights (coefficients) such that a higher weight has a higher distinguishing power and then calculate an effect which is equivalent to the product of the weight or the coefficient by the number of samples (or leaf count).

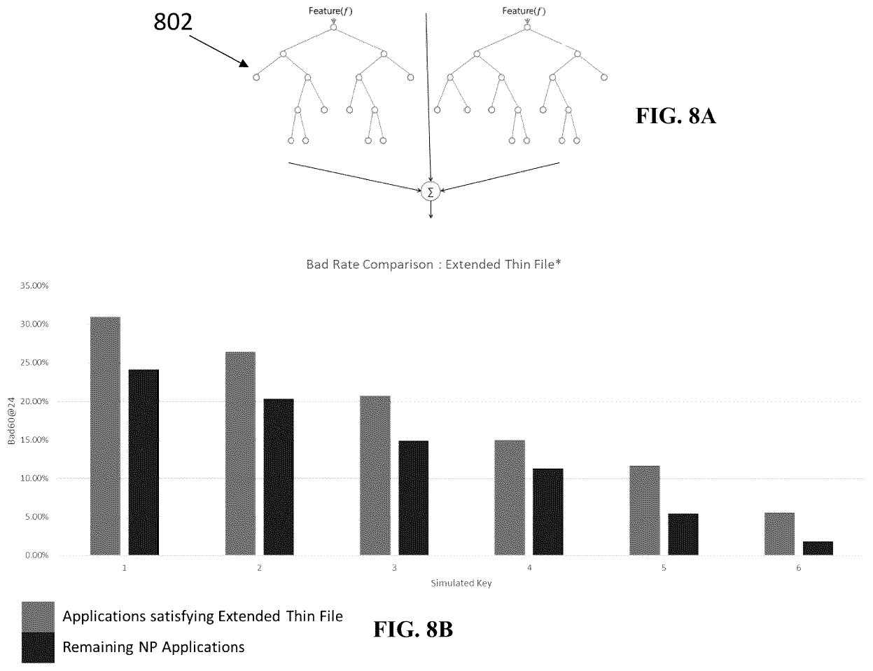

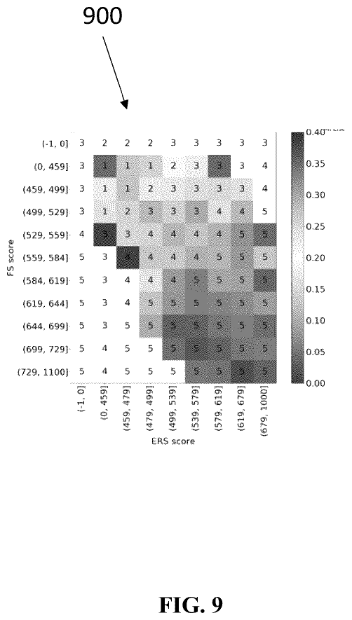

From this rule set 601, the ranking module 110 is configured to sort the rule set 601 by effect and extract the most important rules that provide the most important impact or effect by population. For example, the ranking module 110 may be configured to extract a predefined number of the most important rules and subsequently feed this information into a testing and recommendation module 112 for subsequent optimizations of the machine learning algorithm 103. This identities in an interpretable manner, the data driven segments where the existing implementation of the machine learning algorithm 103 and predictor 113 is suboptimal and requires updating. This may include the recommendation module 112 being configured to make modification to predictions associated with the most important rules (e.g. increase or decrease likelihood of delinquency) to simulate whether this cause an improvement in the prediction error. In one aspect, select rules learned by the tree ensembles may be implemented as features in a linear model for improved prediction. Additionally, in at least some aspects, the ranking module 110 may be configured to discard low coverage rules (e.g. rules having a low effect) that may cause overfitting of the model and thus the testing and recommendation module 112 may invoke such an update of features in the predictor 113. The testing and recommendation module 112 may thus be configured to display the generated rules, such as the rule set 601 including associated effect information on a user interface associated with the engine 100 such as the computing device 200 and/or may be configured to generate the subset of high ranking rules having the highest effect and perform testing on the underlying features to simulate whether a higher or lower prediction score (e.g. risk score) should be assigned for the associated feature interaction and rules in a given rule identified. Examples of such a “key” or score simulation are shown at FIG. 8B which illustrates simulated key for a particular feature as compared to other features, thus the testing and recommendation module 112 being configured to calculate bad rate and provide key swap recommendations to build out a new score card and performance error. As illustrated in FIG. 9, the testing and recommendation module 112 may generate graphic visualizations such an impact graph 900, for display on a user interface of the computing device 200 to show evaluations of impact. In one embodiment, once the engine 100 identifies the sub-optimal pockets and tunes the ensemble tree module 106 to co-operate with the rule interpretation module 108 and the ranking module 110 to determine and discover from hidden patterns, a set of rules having the highest effect on the sub-optimal pocket identified (e.g. by using the performance error of a prior trained and generated model as a target variable for the ensemble trees in the ensemble tree module 106, then the impact of modifying the prediction (e.g. risk key or risk score) generated by the prior model is calculated as shown in Table 1.

Table 1 illustrates effect of integrating a subset of example rules as generated by the ranking module 110 having the highest importance or effect and aggregating such rules to determine an assignment of a new key swap, or risk score based on an input of applications for loan.

| | | % Applications | Net Key Swap |
|---|---|---|---|
| Rule ID | Rule | Satisfying Rule | Impact |
| 1 | Recent Trade and | 11% | Swap down |
| | Public Record | | |
| | Collection with | | |
| | High Inquiries | | |
| 2 | Long Tenure and | 14% | Swap up |
| | Established Credit | | |
| 3 | Extended thin file | 27% | Swap down |
| 1 + 2 + 3 | Combination of 1, | 43% | Swap down |
| | 2, and 3 | | |

In one embodiment, the recommendation and testing and recommendation module 112 is configured to generate detailed analysis on key swaps for swapping out the risk keys determined by the algorithm 103, such as may be generated by the machine learning algorithm 103 for improving the prediction process and automating same. Accordingly, as describe the engine 100 is configured to generate new rules (e.g. rule set 601 in FIG. 6) using data-driven tree based models (e.g. multiple decision trees 302 in FIG. 3, decision tree set 602 in FIG. 6 using feature aggregation process shown as first example process 802 in FIG. 8A illustrating combination of rules from different trees in the tree ensemble) with feature extraction and automatic rule generation and applying such analysis for improved subsequent predictions (e.g. subsequent iterations of the machine learning algorithm 103, or subsequent predictive models correcting the predictions and performing enhancements of the machine learning algorithm 103 by utilizing the identified significant rules of interest which contribute to the prediction error and performing modifications to improve the performance or prediction error).

In one embodiment, the comparison module 104 and the rule interpretation module 108 may further be configured to automatically additionally identify suboptimal pockets by plotting an identified feature (e.g. extended thin file) of interest against a risk key and plotting every risk key that falls under an identified rule including that given feature as shown in FIG. 8B and if other applications have a significantly different prediction, e.g. higher risk of delinquency, that indicates the predictor 113 model is not effectively capturing the identified feature (e.g. extended thin file) and thus, may recommend a swap up or down of the prediction (e.g. risk key) depending upon the plot (e.g. shown in FIG. 8B) and the remaining other application behaviours.

Generally, the system 150 is configured to provide a framework and method to augment existing machine learning strategies (e.g. the predictor 113) by automatically finding the areas or segments in the input data that the current strategy is sub-optimal in its prediction, and determining corresponding rules via the rule interpretation module 108 and thereby gaps in the existing strategy as well as detection of whether swapping out keys or risk scores (e.g. which the predictor 113 was predicting) as associated with the rules and features associated to be suboptimal then improves the predicted performance of the predictor 113. For example, this may include modifying the prediction values associated with a particular identified rule for an identified rule of interest to determine whether it yields improved prediction performance or comparing the features for the suboptimal rules and determining whether other population segments (e.g. see FIG. 8B) in the input data have been associated with different predictions (e.g. key assignments) thereby updating the key assignment accordingly.

Conveniently, in at least one embodiment, the rule interpretation module 108 generates interpretable rules and in this way, since producing a machine learning model may be complex and risky, the engine 100 provides an enhancement solution whereby the outputs do not need a validation process as the output is a set of easily interpretable an implementable rules which may be implemented in production via the testing and recommendation module 112.

In at least one implementation, the ensemble tree module 106 utilizes tree ensembles such as gradient boosted trees to generate the rules via the rule interpretation module 108. The rule interpretation module 108 is configured as noted earlier to communicate and cooperate with the ensemble tree module 106 to transform tree ensembles into its constituent rules by examining every leaf node of that tree ensemble which represents a rule. Referring to FIG. 3, shown is a set of ensemble decision trees, T1, T2, and T3 and example leaf nodes 304. Referring to

FIGS. 3-6, each rule may be defined via the path that taken in a tree such that each node represent a subpart of the rules and once the leaf node is reached, it represents the entire rule set (e.g. rule set 601 being an aggregation of the rules for the ensemble trees).

Referring again to FIGS. 1 to 6, every leaf node, including example leaf nodes 304 has a weight attached to it and the tree ensemble via the ensemble tree module 106 takes a weighted sum of the weight in the node multiplied by which leaf node an occurrence has landed in. Thus, referring to the rule interpretation module 108, it converts tree ensembles into easily interpretable rules. Conveniently, tree ensembles employed by the ensemble tree module 106 are accurate and provide high performance but in order to make these interpretable and not blackboxes, the rule interpretation module 108 is configured to translate the information from the tree ensembles (e.g. multiple decision trees 302) into rules.

Referring to FIGS. 1-6, the ensemble tree module 106 is configured to train a first decision tree on initial data (e.g. for predicting a target variable) and then calculate error of each prediction that the first tree made (e.g. first tree 302A), and subsequent tree (e.g. second tree 302B) trained based on error from the prior tree until the final tree in the sequence (e.g. final tree 302N), etc. In this way, the ensemble tree module 106 utilizes every subsequent tree to augment predictions made by the previous trees. Referring to FIG. 3, the multiple decision trees 302 add their predictions together from first tree 302A T1 to final tree 302N such that the prediction is a sum of the weights in the leaf nodes. In every single tree, the sample will end up in one of the leaf nodes which has a weight attached to that leaf node (e.g. example leaf nodes 304). By adding the weights of all of the leaf nodes, the prediction may be obtained. The following illustrates the example process performed by the ensemble tree module 106 to generate the prediction.

Prediction=T₁+T₂+ . . . +Tₙ a.

ŷᵢ=Σᵢ₌₁^{N}Tᵢ b.

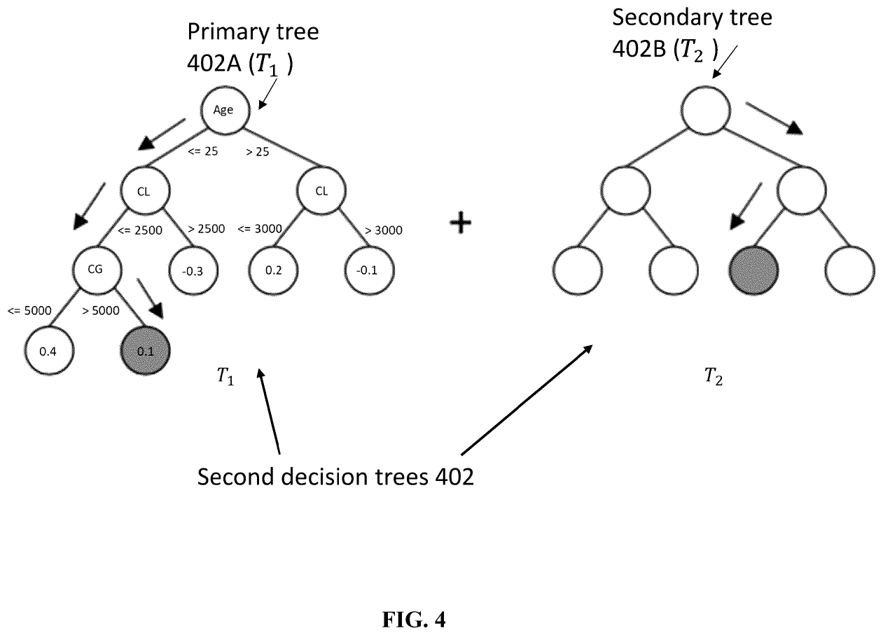

In the example of FIG. 4, the prediction performed by the ensemble tree module 106 in the first tree or the primary tree 402A T1, may be generated in a linear format by the module as follows and used to generate the rules from the tree ensembles.

$$a . {T}_{1} = 0.4 ( Age \leq 25 AND CL \leq 2500 AND CG \leq 5000 ) + 0.1 ( Age \leq 25 AND CL \leq 2500 AND CG > 5000 ) - 0.3 ( Age \leq 25 AND CL > 2500 ) + 0.2 ( Age > 25 AND CL \leq 3000 ) - 0.1 ( Age > 25 AND CL > 3000 )$$

$$b . ( x ) = \{ \begin{matrix}1 & if x is true \\ 0 & otherwise\end{matrix}$$

To generate the prediction for the second decision trees 402 shown in FIG. 4, the prediction of the primary tree 402A T1 is added to the secondary tree to generate a linear model representation output thereof. In this way, the linear model has each of the features as leaf nodes whereby the prediction is a product of the coefficient and the features whereby the features are leaf nodes and all the tree predictions are summed to obtain the final prediction at the output from all trees of the ensemble.

Thus, the overall prediction of an ensemble set is the summation of all of the leaf nodes that a sample ended up in.

Such linear models extracted by the ensemble tree module 106 are then utilized to generate the rules from all trees of the ensemble such that each rule is a combination of the set of features used in a particular tree (e.g. T1 . . . TN), the feature values or boundaries and having an associated weight estimate or coefficient. Put another way, every rule and feature may be present in the linear model for the prediction and provides a linear relationship between features. An example table of a rule set 601 is illustrated in FIG. 6 as extracted from decision tree set 602.

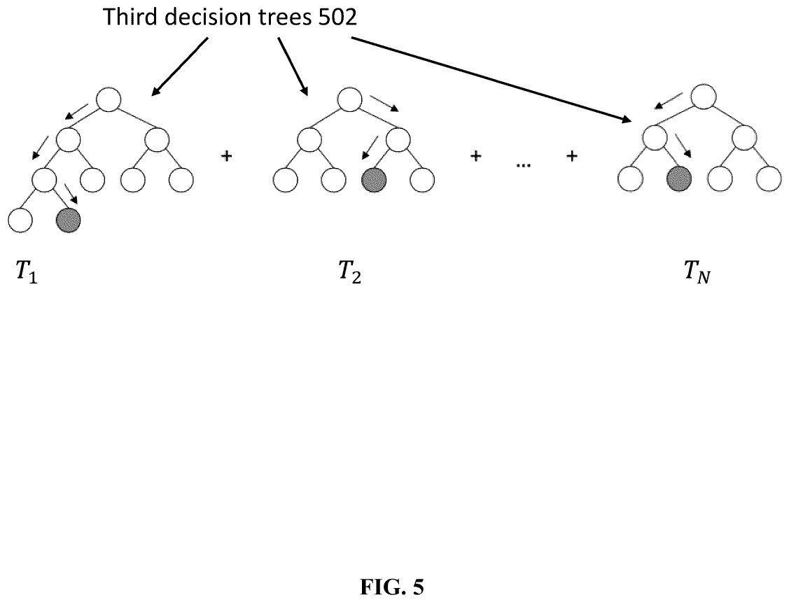

For example, referring to the set of ensemble trees in FIG. 5, shown as the third decision trees 502 composed of trees T1 . . . TN, then the prediction may be performed by the ensemble tree module 106 as follows in terms of a linear model:

Tᵢ=Σ_{L}_{ⱼ}_{∈T}_{ᵢ}wⱼ [symbol] (Lⱼ) a.

ŷᵢ=Σᵢ₌₁^{N}Tᵢ=Σᵢ₌₁^{N}Σ_{L}_{ⱼ}_{∈T}_{ᵢ}wⱼ [symbol] (Lⱼ)=Σ_{L}_{ₖ}_{∈{T}_{₁}_{, . . . , T}_{ₙ}_{}}wₖ [symbol] (Lₖ) b.

Referring to FIG. 6 with reference to FIGS. 1-5, an example decision tree set 602 is shown as converted to a rule set 601 via the engine 100. Given a leaf node which represents a rule, the engine 100 may examine which proportion are classified in one prediction class versus another (e.g. delinquent vs not) and rank order by the effect to get the most important rules (via the rule interpretation module 108 and the ranking module 110) to capture large amount of population and high distinguishing power between classifications, e.g. delinquent or not as may be illustrated by example rule set 601.

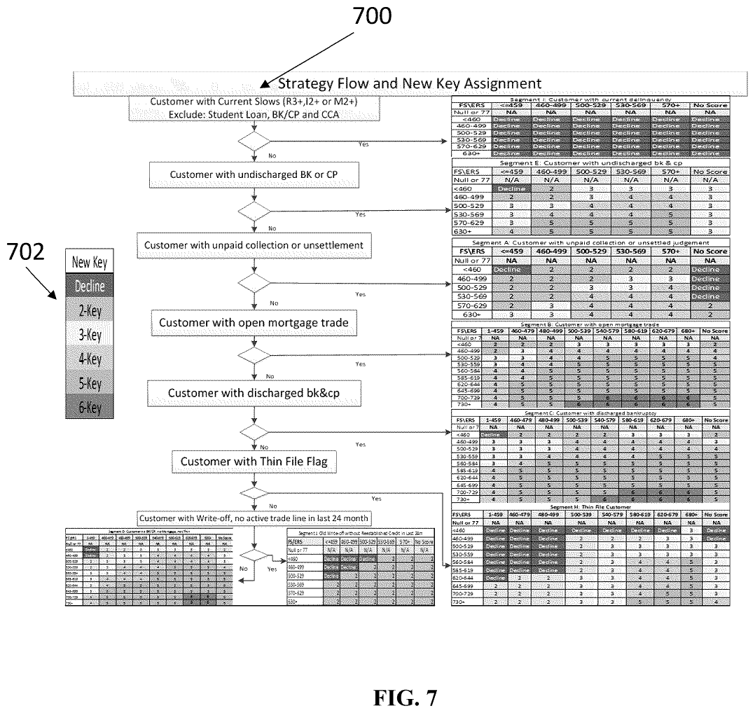

FIG. 2 illustrates example computer components of an example computing device, such as a computing device 200 for providing the system 150 including the model enhancement engine 100 described with respect to FIG. 1 (and example operations in FIGS. 3-10), in accordance with one or more aspects of the present disclosure.

The computing device 200 comprises one or more processors 201, one or more input devices 202, one or more communication units 205, one or more output devices 204 (e.g. providing one or more graphical user interfaces on a screen of the computing device 200) and a memory 203. Computing device 200 also includes one or more storage devices 207 storing one or more computer modules such as the model enhancement engine 100, a control module 208 for orchestrating and controlling communication between various modules (e.g. comparison module 104, ensemble tree module 106, rule interpretation module 108, ranking module 110, testing and recommendation module 112, performance database 114 and the modules shown in FIG. 1 as well as communication modules to communicate with the predictor 113 comprising historical data 101, active data 102 and machine learning algorithm 103 which may reside on the computing device 200 or another computing device communicating with and coupled to the computing device 200) and data stores of the engine 100. The computing device 200 may comprise additional computing modules or data stores in various embodiments (e.g. as shown in FIG. 1). Additional computing modules and devices that may be included in various embodiments, are not shown in FIG. 2 to avoid undue complexity of the description, such as communication with one or more other computing devices, as applicable, for obtaining the historical data 101 and/or the active data 102 including via a communication network, not shown.

Communication channels 206 may couple each of the components including processor(s) 201, input device(s) 202, communication unit(s) 205, output device(s) 204, memory 203, storage device(s) 207, and the modules stored therein for inter-component communications, whether communicatively, physically and/or operatively. In some examples, communication channels 206 may include a system bus, a network connection, an inter-process communication data structure, or any other method for communicating data.

One or more processors 201 may implement functionality and/or execute instructions within the computing device 200. For example, processor(s) 201 may be configured to receive instructions and/or data from storage device(s) 207 to execute the functionality of the modules shown in FIG. 2, among others (e.g. operating system, applications, etc.). Computing device 200 may store data/information (e.g. historical account data 101; active account data 102; prediction data and optimization data provided from the testing and recommendation module 112) to storage device(s) 207.

One or more communication units 205 may communicate with external computing devices via one or more networks by transmitting and/or receiving network signals on the one or more networks. The communication units 205 may include various antennae and/or network interface cards, etc. for wireless and/or wired communications.

Input devices 202 and output devices 204 may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 206).

The one or more storage devices 207 may store instructions and/or data for processing during operation of the computing device 200. The one or more storage devices 207 may take different forms and/or configurations, for example, as short-term memory or long-term memory. Storage device(s) 207 may be configured for short-term storage of information as volatile memory, which does not retain stored contents when power is removed. Volatile memory examples include random access memory (RAM), dynamic random access memory (DRAM), static random access memory (SRAM), etc. Storage device(s) 207, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable read-only memory (EPROM) or electrically erasable and programmable read-only memory (EEPROM).

The computing device 200 may include additional computing modules or data stores in various embodiments. Additional modules, data stores and devices that may be included in various embodiments may not be shown in FIG. 2 to avoid undue complexity of the description. Other examples of computing device 200 may be a tablet computer, a person digital assistant (PDA), a laptop computer, a tabletop computer, a portable media player, an e-book reader, a watch, a customer device, a user device, or another type of computing device.

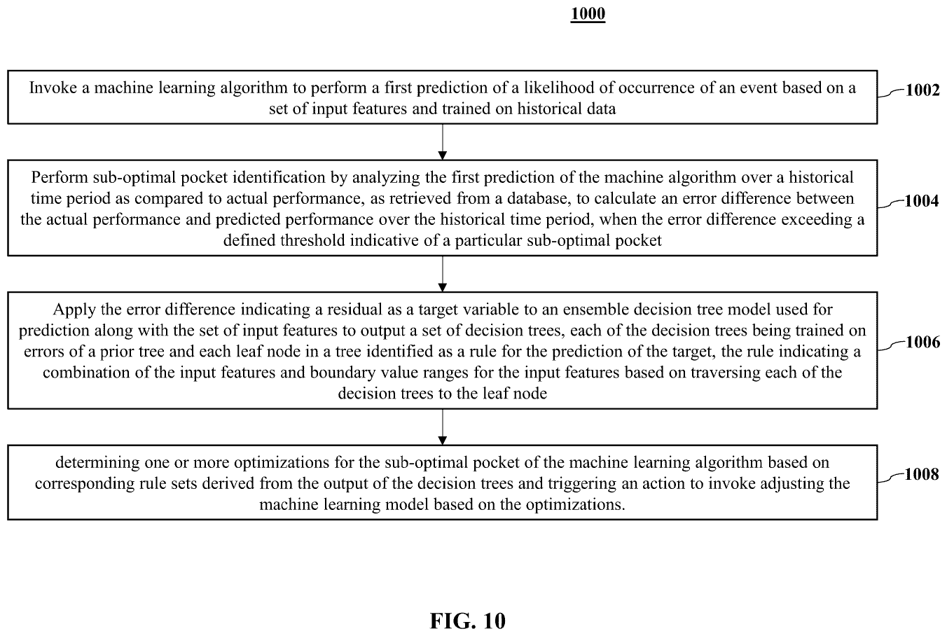

Referring to FIG. 10, shown is an example flowchart of operations 1000 illustrating a method, which may be performed by the computing device 200 of FIG. 2 implementing the system 150 and the model enhancement engine 100 of FIG. 1 for determining optimizations and enhancements for an existing machine learning model and algorithm (e.g. predictor 113) and if appropriate, implementing same for improving the suboptimal predictions generated by the predictor 113 in a future iteration of the model or via adjustments made by the engine 100 based on interpretable rules extracted via ensemble trees trained using a prediction performance error (e.g. residual) of the machine learning algorithm 103 as a target variable.

The computing device 200 may comprise a processor configured to communicate with a display to provide a graphical user interface as well as communication interfaces to communicate with the predictor 113 (e.g. stored on the computing device 200 or accessible via a network and stored on an external computing device or data store). Additionally, instructions (stored in a non-transient storage device) when executed by the processor, configure the computing device to perform example operations such as operations 1000 in FIG. 10 and those currently disclosed herein.

Referring to FIG. 10 with reference to FIGS. 1 and 2, at step 1002, operations of the computing device invoke a previously trained, generated and implemented machine learning algorithm (e.g. machine learning algorithm 103) to perform a first prediction of a likelihood of occurrence of an event or happening based on a set of input features (e.g. active data 102) and previously trained on historical data (e.g. historical data 101).

At step 1004, following step 1002, operations perform sub-optimal pocket identification by analyzing the first prediction of the machine learning algorithm over a historical time period as compared to actual performance (e.g. error=actual performance−predicted performance), as retrieved from a database such as the performance database 114, to calculate an error difference between the actual performance and predicted performance over the historical time period. Thus, when the error difference exceeds a defined threshold this is indicative of a particular sub-optimal pocket, e.g. performance in that segment of time below desired.

At step 1006, following step 1004, operations apply the error difference indicating a residual as a target variable to an ensemble decision tree model used for prediction along with the set of input features (e.g. some or all of the features of interest extracted from the historical data 101 and/or the active data 102) to output a set of decision trees. Example sets of decision trees being shown in FIGS. 3-6 and 8A. Each of the decision trees are trained on errors of a prior trained tree (e.g. in the multiple decision trees 302 of FIG. 3, second tree 302B T2 is trained on errors of first tree 302A T1 continuing iteratively onto the final tree 302N being trained on error of N-1 tree) and each leaf node (see example leaf nodes 304 in FIG. 3) in a tree identified as a rule for the prediction of the target (e.g. the prediction error). As noted earlier, each leaf node in a tree is converted via operations of the computing device to a rule such that trees are converted to rule sets. Each rule indicating a combination of the input features, their relationships/interactions with one another and boundary value ranges for the input features (e.g. features selected from original features in the historical data 101 and/or the active data 102) based on traversing each of the decision trees to the leaf node. Example of a rule set 601 illustrated in

FIG. 6 and another rule set for a different ensemble tree set shown in FIG. 11 as second rule set 1102.

Thus, in at least some aspects, operations of the computing device are configured to interpret tree ensembles (e.g. as provided by the ensemble tree module 106) and convert black box models into a set of interpretable rules (e.g. rule set 601 or second rule set 1102) and providing a global prediction to see how the model works overall such as to see how each ensemble tree is working to make a prediction, e.g. the performance error and generating the set of rules which are being used by the tree, as well as the weighting for each rule (e.g. as implemented by the rule interpretation module 108 in FIGS. 1 and 2) to generate metadata about the rules and output a set of interpretable rules. As shown in the rule sets of FIGS. 6 and 11, operations of the computing device assign a value to each feature such as to define how much each feature contributed to each prediction.

In at least some aspects, the generated tree ensembles and the corresponding generate rule sets provided by operations of the computing device combine many feature variables at once providing interactions between the feature variables as the variables are typically not independent and affect each other.

At step 1008, operations of the computing device are configured to determine one or more optimizations for the sub-optimal pocket of the machine learning algorithm based on corresponding rule sets derived from the output of the decision trees and triggering an action to invoke adjusting the machine learning model based on the optimizations. This may include for example generating simulated key or risk score (variable being predicted by the initial model) for the feature(s) satisfying the criteria set and values identified in one or more of the top set of rules (e.g. having the highest effect) and comparing this feature satisfying the criteria and corresponding key to the remaining input data having this feature (but may not necessarily satisfy the criteria for the values identified in the rule set) and thus determining that a swap or change of the prediction value associated with the identified feature in the rule set is needed to optimize and improve the performance and thus effecting said optimization for the predictor 113. An example of such a simulated comparison to determine the behavior of remaining data having the identified feature is shown at FIG. 8B.

Conveniently, in at least some aspects, the ensemble trees (e.g. gradient boosted trees) are converted by operations of the computing device, to a set of highly interpretable rules which can clearly depict how each of the ensemble trees is performing its prediction. As described, in some aspects, a subset of rules may account for majority of power of the prediction in the tree and thus can be visualized and implemented to determine the most important rules such as by sorting such rules (e.g. shown by example in FIG. 6 or 11) by effect. In some aspects, such rule information may also be rendered on an interactive interface element of a graphical user interface (e.g. of the computing device 200 in FIG. 2) for subsequent interaction and confirmation or selection of the rules to further effect the optimizations generated for the predictor 113 in FIG. 1.

Further conveniently, in at least some aspects, the proposed systems and techniques may be added on top of existing machine learning models, such as the predictor 113 to provide enhancements and improvements to the model. As noted earlier, there may risk involved with replacing models which are not performing well altogether. The proposed systems and methods provide an improvement, in at least some aspects by operations of the computing device automatically looking for areas of improvement and fixing the gaps and doing so by building interpretable rules such that they may be easily implemented for execution within a computing system, such as that shown in FIG. 1.

Conveniently and referring to FIG. 10 with reference to FIGS. 1 and 2, in at least some aspects, operations of the computing device automatically augment techniques implemented by an existing machine learning model (e.g. predictor 113) and provide interpretable rule sets (e.g. via the rule interpretation module). In at least some aspects, the operations of the computing device are configured to predict errors of an existing strategy and model (e.g. predictor 113). For example, for every applicant in historical data, the comparison module 104 determines was the output was, what the associated prediction (e.g. risk key) was and as well as whether that predicted event actually occurred (e.g. whether historical data indicates actual delinquency based on monitoring behaviours of transactions in the computing environment). In at least one aspect, the comparison module 104 may calculate the difference in the expected and actual occurrence of event and detect any errors in an existing model strategy (e.g. predictor 113) such as to determine patterns in the detected error and underlying features (as the tree ensemble is trained with the error as the target variable). Conveniently, operations of the computing device, in at least some embodiments, defines patterns in the features and interactions where the existing strategy (e.g. predictor 113) is not performing well and thus utilize same for providing and implementing augmentations to improve the model performance of an existing model (e.g. the predictor 113) without replacing the model as a whole.

One or more currently preferred embodiments have been described by way of example. It will be apparent to persons skilled in the art that a number of variations and modifications can be made without departing from the scope of the disclosure as defined in the claims.

What is claimed is:

1. A computing system for optimizing a machine learning model for performing predictions, the computer system comprising a processor, a storage device and a communication device where each of the storage device and the communication device is coupled to the processor, the storage device storing instructions, which when executed by the processor configured the computing system to:
invoke a machine learning algorithm to perform a first prediction of a likelihood of occurrence of an event based on a set of input features and trained on historical data;
perform sub-optimal pocket identification by analyzing the first prediction of the machine learning algorithm over a historical time period as compared to actual performance, as retrieved from a database, to calculate an error difference between the actual performance and predicted performance over the historical time period, when the error difference exceeding a defined threshold indicative of a particular sub-optimal pocket;
apply the error difference indicating a residual as a target variable to an ensemble decision tree model used for prediction along with the set of input features to output a set of decision trees, each of the decision trees being trained on errors of a prior tree and each leaf node in a tree identified as a rule for the prediction of the target, the rule indicating a combination of the input features and boundary value ranges for the input features based on traversing each of the decision trees to the leaf node; and,
determine one or more optimizations for the sub-optimal pocket of the machine learning algorithm based on corresponding rule sets derived from the output of the decision trees and triggering an action to invoke adjusting the machine learning model based on the optimizations.

2. The computing system of claim 1, wherein the prediction performed by the decision tree model is a sum of respective predictions performed by each one of the set of decision trees generated and combined to form the prediction.

3. The computing system of claim 2, wherein the instructions, when executed by the processor further cause the system to:
generate a linear model, for each leaf node of each decision tree in the set of decision trees having a corresponding rule representing an interpretable decision tree, for predicting the target variable based on a sum of a product of weighted values of features and the corresponding rule, each weighting automatically generated and associated with probabilities for the features in a given node.

4. The computing system of claim 3, wherein the instructions further cause the system to:
rank each rule generated from each leaf node of each decision tree in the set of decision trees to generate a ranked list by calculating an effect of each rule, the effect calculated as a product of a leaf count indicating a frequency of occurrence of nodes satisfying a particular rule within the decision tree and a coefficient for the particular rule indicating the weighting for features in the particular rule based on a summation of all of the decision trees in the set of decision trees.

5. The computing system of claim 4, wherein the instructions causing the system to determine the optimizations further comprises:
selecting a predefined number of rules in the ranked list having a highest value of the calculated effect as compared to remaining other rules;
automatically inputting the selected rules to a feature analysis engine for simulating modifying the first prediction for each of the selected rules and simulating whether the machine learning algorithm improves in performance based on the modification; and
in response to an improvement detected based on the modification, defining the modification as one of the optimizations for automatically adjusting the machine learning algorithm.

6. The computing system of claim 5, wherein the instructions, when executed by the processor further cause the system to:
select a second set of rules in the ranked list having the calculated effected below a defined threshold as compared to the remaining other rules;
determine one or more corresponding features and associated values in the second set of rules; and,
invoke the machine learning algorithm to remove the one or more corresponding features having the associated values from the input features thereby removing irrelevant features from the first prediction.

7. The computing system of claim 1, wherein the ensemble decision tree model is selected from one of: gradient boosted machine, light gradient boosted machine, extreme gradient boosted, random forest, and bagging algorithms.

8. The computing system of claim 3, wherein the prediction for the ensemble decision tree model is computed as a sum of predictions for all of the set of decision trees and computed as:
ŷᵢ=Σᵢ₌₁^{N}Tᵢ
with ŷᵢ indicating a total prediction and Tᵢ referring to each tree in the set of decision trees.

9. The computing system of claim 8, wherein the prediction for the ensemble decision tree model is converted to a sum of a product of probability of occurrence for each leaf node and a corresponding rule set for said each leaf node in traversing a path throughout each decision tree and computed as:
Tᵢ=Σ_{L}_{ⱼ}_{∈T}_{ᵢ}wⱼ [symbol] (Lⱼ)
with w representing the weighting; and L representing a particular rule in terms of original input features as a linear model; and the prediction represented as:
ŷᵢ=Σᵢ₌₁^{N}Tᵢ=Σᵢ₌₁^{N}Σ_{L}_{ⱼ}_{∈T}_{ᵢ}wⱼ [symbol] (Lⱼ)=Σ_{L}_{ₖ}_{∈{T}_{₁}_{, . . . , T}_{ₙ}_{}}wₖ [symbol] (Lₖ)
such that:
$$( x ) = \{ \begin{matrix}1 & if x is true \\ 0 & otherwise\end{matrix}$$

10. A computer implemented method for optimizing a machine learning model for performing predictions, the method comprising:
invoking a machine learning algorithm to perform a first prediction of a likelihood of occurrence of an event based on a set of input features and trained on historical data;
performing sub-optimal pocket identification by analyzing the first prediction of the machine learning algorithm over a historical time period as compared to actual performance, as retrieved from a database, to calculate an error difference between the actual performance and predicted performance over the historical time period, when the error difference exceeding a defined threshold indicative of a particular sub-optimal pocket;
applying the error difference indicating a residual as a target variable to an ensemble decision tree model used for prediction along with the set of input features to output a set of decision trees, each of the decision trees being trained on errors of a prior tree and each leaf node in a tree identified as a rule for the prediction of the target, the rule indicating a combination of the input features and boundary value ranges for the input features based on traversing each of the decision trees to the leaf node; and,
determining one or more optimizations for the sub-optimal pocket of the machine learning algorithm based on corresponding rule sets derived from the output of the decision trees and triggering an action to invoke adjusting the machine learning model based on the optimizations.

11. The method of claim 10, wherein the prediction performed by the decision tree model is a sum of respective predictions performed by each one of the set of decision trees generated and combined to form the prediction.

12. The method of claim 11, further comprising:
generating a linear model, for each leaf node of each decision tree in the set of decision trees having a corresponding rule, representing an interpretable decision tree for predicting the target variable based on a sum of a product of weighted values of features and the corresponding rule, each weighting automatically generated and associated with probabilities for the features in a given node.

13. The method of claim 12, further comprising:
ranking each rule generated from each leaf node of each decision tree in the set of decision trees to generate a ranked list by calculating an effect of each rule, the effect calculated as a product of a leaf count indicating a frequency of occurrence of nodes satisfying a particular rule within the decision tree and a coefficient for the particular rule indicating the weighting for features in the particular rule based on a summation of all of the decision trees in the set of decision trees.

14. The method of claim 13, wherein determining the optimizations further comprises:
selecting a predefined number of rules in the ranked list having a highest value of the calculated effect as compared to remaining other rules;
automatically inputting the selected rules to a feature analysis engine for simulating modifying the first prediction for each of the selected rules and simulating whether the machine learning algorithm improves in performance based on the modification; and
in response to an improvement detected based on the modification, defining the modification as one of the optimizations for automatically adjusting the machine learning algorithm.

15. The method of claim 14, further comprising:
selecting a second set of rules in the ranked list having the calculated effected below a defined threshold as compared to the remaining other rules;
determining one or more corresponding features and associated values in the second set of rules;
invoking the machine learning algorithm to remove the one or more corresponding features in the second set of rules having the associated values from the input features thereby removing irrelevant features from consideration in the first prediction.

16. The method of claim 10, wherein the ensemble decision tree model is selected from one of: gradient boosted machine, light gradient boosted machine, extreme gradient boosted, random forest, and bagging algorithms.

17. The method of claim 12, wherein the prediction for the ensemble decision tree model is computed as a sum of predictions for all of the set of decision trees and computed as:
ŷᵢ=Σᵢ₌₁^{N}Tᵢ
with ŷᵢ indicating a total prediction and Tᵢ referring to each tree in the set of decision trees.

18. The method of claim 17, wherein the prediction for the ensemble decision tree model is converted to a sum of a product of probability of occurrence for each leaf node and a corresponding rule set for said each leaf node in traversing a path throughout each decision tree and computed as:
Tᵢ=Σ_{L}_{ⱼ}_{∈T}_{ᵢ}wⱼ [symbol] (Lⱼ)
with w representing the weighting; and L representing a particular rule in terms of original input features as a linear model; and the prediction represented as:
ŷᵢ=Σᵢ₌₁^{N}Tᵢ=Σᵢ₌₁^{N}Σ_{L}_{ⱼ}_{∈T}_{ᵢ}wⱼ [symbol] (Lⱼ)=Σ_{L}_{ₖ}_{∈{T}_{₁}_{, . . . , T}_{ₙ}_{}}wₖ [symbol] (Lₖ)
such that:
$$( x ) = \{ \begin{matrix}1 & if x is true \\ 0 & otherwise\end{matrix}$$

19. The method of claim 14, further comprising: rendering the ranked list of rules in the set of decision trees with the effect of each rule as an interactive interface element on a graphical user interface for confirming one of the optimizations generated for adjusting the machine learning algorithm.

20. A computer program product comprising a non-transient storage device storing instructions that when executed by at least one processor of a computing device, configure the computing device for optimizing a machine learning model for performing predictions, the instructions once executed configure the computing device to:
invoke a machine learning algorithm to perform a first prediction of a likelihood of occurrence of an event based on a set of input features and trained on historical data;
perform sub-optimal pocket identification by analyzing the first prediction of the machine learning algorithm over a historical time period as compared to actual performance, as retrieved from a database, to calculate an error difference between the actual performance and predicted performance over the historical time period, when the error difference exceeding a defined threshold indicative of a particular sub-optimal pocket;
apply the error difference indicating a residual as a target variable to an ensemble decision tree model used for prediction along with the set of input features to output a set of decision trees, each of the decision trees being trained on errors of a prior tree and each leaf node in a tree identified as a rule for the prediction of the target, the rule indicating a combination of the input features and boundary value ranges for the input features based on traversing each of the decision trees to the leaf node; and,
determine one or more optimizations for the sub-optimal pocket of the machine learning algorithm based on corresponding rule sets derived from the output of the decision trees and triggering an action to invoke adjusting the machine learning model based on the optimizations.
